(19) United States
(12) Patent Application Publication
(10) Pub. No.: US 2024/0086257 A1
(43) Pub. Date: Mar. 14, 2024

(54) DIRECT DATAFLOW COMPUTE-IN-MEMORY ACCELERATOR INTERFACE AND ARCHITECTURE

(71) Applicant: MemryX Incorporated, Ann Arbor, MI (US)

(72) Inventors: Wei LU, Ann Arbor, MI (US); Keith KRESSIN, Ann Arbor, MI (US); Mohammed ZIDAN, Ann Arbor, MI (US); Jacob BOTIMER, Ann Arbor, MI (US); Timothy WESLEY, Ann Arbor, MI (US); Chester LIU, Ann Arbor, MI (US)

(21) Appl. No.: 17/945,042

(22) Filed: Sep. 14, 2022

(51) Int. Cl. G06F 9/50; G06F 9/54

(52) U.S. Cl. CPC G06F 9/5083; G06F 9/54

(57) ABSTRACT

A computing system including an application processor and a direct dataflow compute-in-memory accelerator. The direct dataflow compute-in-memory accelerator executes is configured to an execute accelerator task on accelerator data to generate an accelerator task result. An accelerator driver is configured to stream the accelerator task data from the application processor to the direct dataflow compute-in-memory architecture without placing a load on the application processor. The accelerator drive can also return the accelerator task result to the application processor.

### BACKGROUND OF THE INVENTION

Computing systems have made significant contributions toward the advancement of modern society and are utilized in a number of applications to achieve advantageous results. Applications such as artificial intelligence, neural processing, machine learning, big data analytics and the like perform computations on large amounts of data. In conventional computing systems, data is transferred from memory to one or more processing units, the processing units perform calculations on the data, and the results are then transferred back to memory.

Referring to FIG. 1, a convention computing system is illustrated. The conventional computing system 100 can include a host processor 110, a neural processing unit 120, a graphics processing unit 130, a system hub 140, a memory controller 150, an image signal processor 160, and system memory 170, among other subsystems. In conventional systems, accelerators, like neural processing units 120, graphics processing units 130 and image signal processors 160, utilize resources of the host processor 110 and system memory 170. For example, an artificial intelligence image recognition task may involve the host processor 110 receiving a stream of image data from the image signal processor 160, and storing the images in system memory 170. The host processor 110 controls image recognition tasks on the graphics processing unit 130 and or neural processing unit 120 to detect objects, and determine their class and associated confidence levels. Therefore, the control of image recognition tasks places a significant load on the host processor 110. Furthermore, the transfer of large amounts of data from memory 170 to the host processor 110, neural processing unit and or graphics processing unit 130, and back to memory 170 takes time and consumes power. Accordingly, there is a continuing need for improved computing systems that reduce processing latency, data latency and or power consumption.

### SUMMARY OF THE INVENTION

The present technology may best be understood by referring to the following description and accompanying drawings that are used to illustrate embodiments of the present technology directed toward direct dataflow compute-in-memory accelerators. The direct dataflow compute-in-memory accelerators can advantageously work independent of host application processors and therefore do not add loading to the application processor.

In one embodiment, a system can include one or more application processors and one or more direct dataflow compute-in-memory accelerators coupled together by one or more communication interfaces. The one or more direct dataflow compute-in-memory accelerators execute one or more accelerator tasks that process accelerator task data to generate one or more accelerator task results. An accelerator driver streams the accelerator task data from the one or more application processor to the one or more direct dataflow compute-in-memory accelerators and turns the accelerator task results to the one or more application processors.

In another embodiment, an artificial intelligence accelerator method can include initiating an artificial intelligence task by a host processor on a direct dataflow compute-in-memory accelerator through an accelerator driver. Accelerator task data can be streamed through the accelerator driver to the direct dataflow compute-in-memory accelerator. An accelerator task result can be returned from the direct dataflow compute-in-memory accelerator through the accelerator driver.

The accelerator driver enables the use of any number of direct dataflow compute-in-memory accelerators to achieve a desired level of artificial intelligence processing. The accelerator driver allows artificial intelligence tasks to be added to both new and existing computing system designs, which can reduce non-recurring engineering (NRE) costs. Artificial intelligence software can also be upgraded independently from the hardware of the host application processor, also reducing non-recurring engineering (NRE) costs. The accelerator driver and direct dataflow compute-in-memory accelerator reduce or eliminate system bottlenecks of artificial intelligence tasks on conventional computing systems. The reduced load on the application processor, and reduced system memory access provided by the direct dataflow compute-in-memory accelerators and accelerator driver provides for lower power consumption and processing latency.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

Embodiments of the present technology are illustrated by way of example and not by way of limitation, in the figures of the accompanying drawings and in which like reference numerals refer to similar elements and in which:

FIG. 1 shows a computing system according to the conventional art.

FIG. 2 shows a computing system, in accordance with aspects of the present technology.

FIG. 3 shows an artificial intelligence accelerator method, in accordance with aspects of the present technology.

FIG. 4 shows an exemplary accelerator model, such as but not limited to an artificial intelligence (AI) model, in accordance with aspects of the present technology.

FIG. 5 shows an exemplary direct dataflow compute-in-memory accelerator, in accordance with aspects of the present technology.

FIG. 6 shows an exemplary execution of accelerator model, in accordance with aspects of the present technology.

FIG. 7 shows a programming stack, in accordance with aspects of the present technology.

FIG. 8 shows a direct dataflow compute-in-memory accelerator, in accordance with aspects of the present technology.

FIG. 9 shows a direct dataflow compute-in-memory accelerator, in accordance with embodiments of the present technology.

FIG. 10 shows a direct dataflow compute-in-memory accelerator, in accordance with aspects of the present technology.

FIG. 11 shows a direct dataflow compute-in-memory accelerator, in accordance with aspects of the present technology.

FIG. 12 shows a direct dataflow compute-in-memory accelerator, in accordance with aspects of the present technology.

FIGS. 13A-13C shows exemplary implementations of a direct dataflow compute-in-memory accelerator, in accordance with aspects of the present technology.

FIG. 14 shows a relative comparison of efficiency of running artificial intelligence (AI) algorithms on various compute cores.

FIG. 15 shows a relative comparison of performance of artificial intelligence algorithms in a conventional system and the direct dataflow compute-in-memory accelerator.

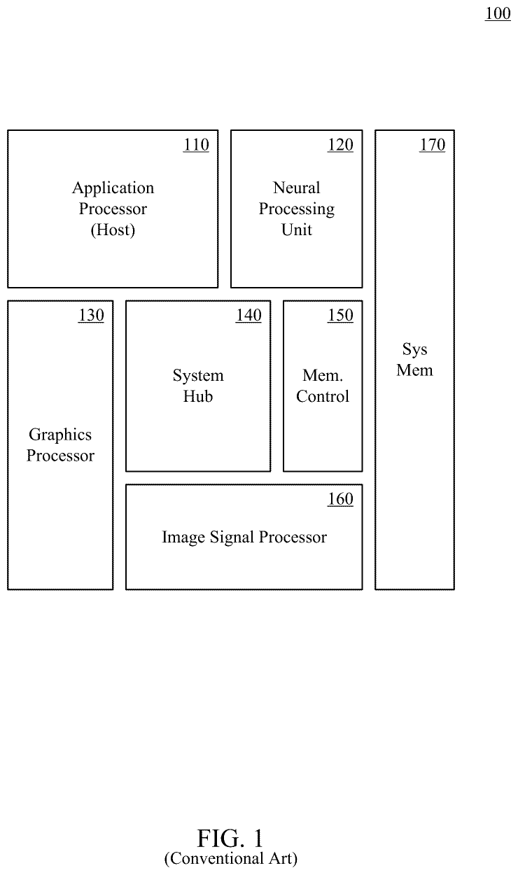

### DETAILED DESCRIPTION OF THE INVENTION

Reference will now be made in detail to the embodiments of the present technology, examples of which are illustrated in the accompanying drawings. While the present technology will be described in conjunction with these embodiments, it will be understood that they are not intended to limit the technology to these embodiments. On the contrary, the invention is intended to cover alternatives, modifications and equivalents, which may be included within the scope of the invention as defined by the appended claims. Furthermore, in the following detailed description of the present technology, numerous specific details are set forth in order to provide a thorough understanding of the present technology. However, it is understood that the present technology may be practiced without these specific details. In other instances, well-known methods, procedures, components, and circuits have not been described in detail as not to unnecessarily obscure aspects of the present technology.

Some embodiments of the present technology which follow are presented in terms of routines, modules, logic blocks, and other symbolic representations of operations on data within one or more electronic devices. The descriptions and representations are the means used by those skilled in the art to most effectively convey the substance of their work to others skilled in the art. A routine, module, logic block and/or the like, is herein, and generally, conceived to be a self-consistent sequence of processes or instructions leading to a desired result. The processes are those including physical manipulations of physical quantities. Usually, though not necessarily, these physical manipulations take the form of electric or magnetic signals capable of being stored, transferred, compared and otherwise manipulated in an electronic device. For reasons of convenience, and with reference to common usage, these signals are referred to as data, bits, values, elements, symbols, characters, terms, numbers, strings, and/or the like with reference to embodiments of the present technology.

It should be borne in mind, however, that these terms are to be interpreted as referencing physical manipulations and quantities and are merely convenient labels and are to be interpreted further in view of terms commonly used in the art. Unless specifically stated otherwise as apparent from the following discussion, it is understood that through discussions of the present technology, discussions utilizing the terms such as “receiving,” and/or the like, refer to the actions and processes of an electronic device such as an electronic computing device that manipulates and transforms data. The data is represented as physical (e.g., electronic) quantities within the electronic device's logic circuits, registers, memories and/or the like, and is transformed into other data similarly represented as physical quantities within the electronic device.

In this application, the use of the disjunctive is intended to include the conjunctive. The use of definite or indefinite articles is not intended to indicate cardinality. In particular, a reference to “the” object or “a” object is intended to denote also one of a possible plurality of such objects. The use of the terms “comprises,” “comprising,” “includes,” “including” and the like specify the presence of stated elements, but do not preclude the presence or addition of one or more other elements and or groups thereof. It is also to be understood that although the terms first, second, etc. may be used herein to describe various elements, such elements should not be limited by these terms. These terms are used herein to distinguish one element from another. For example, a first element could be termed a second element, and similarly a second element could be termed a first element, without departing from the scope of embodiments. It is also to be understood that when an element is referred to as being “coupled” to another element, it may be directly or indirectly connected to the other element, or an intervening element may be present. In contrast, when an element is referred to as being “directly connected” to another element, there are not intervening elements present. It is also to be understood that the term “and or” includes any and all combinations of one or more of the associated elements. It is also to be understood that the phraseology and terminology used herein is for the purpose of description and should not be regarded as limiting. It is also to be understood that the term “compute in memory” includes similar approaches such as “compute near memory”, “compute at memory” and “compute with memory”.

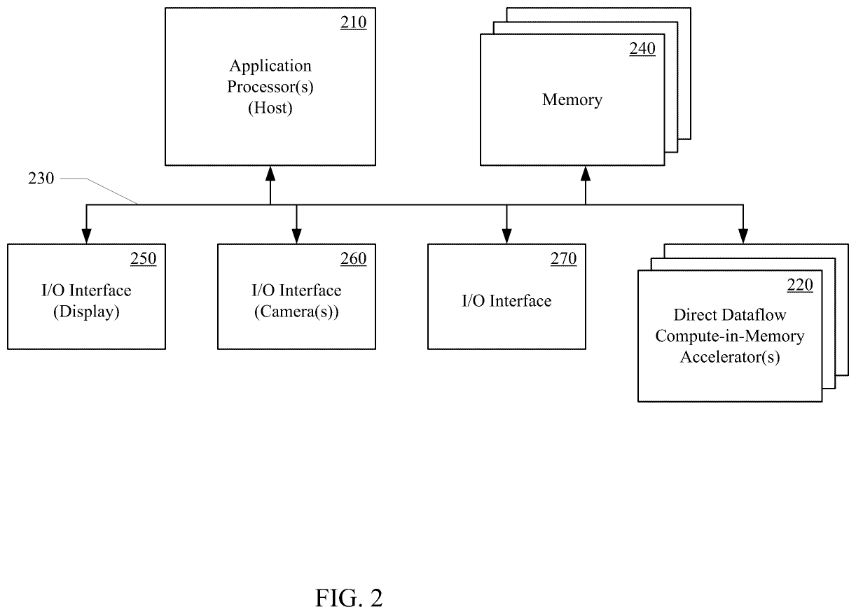

Referring now to FIG. 2, a compute system architecture, in accordance with aspects of the present technology, is shown. The compute system 200 can include one or more application processors 210 and one or more direct dataflow compute-in-memory accelerators 220 coupled to the one or more application processor 210 by one or more communication interfaces 230. The one or more application processors 210 can be a host processor. The one or more processors 210 can be configured to execute an operating system and one or more applications under control of the operating system. The one or more application processors 210 can be any processor hardware architecture, such as but not limited to x86 processor, Arm processor, Xilinx, NXP, MTK, or Rockchip. The operating system can be any operating system, including but not limited to Linux, Ubuntu or Andriod. The one or more communication interfaces can include, but are not limited to, universal serial bus (USB), or peripheral component interface express (PCI-E).

The compute system 200 can further include one or more memories 240 for storing the operating system, one or more applications, and one or more accelerator drivers for execution by the one or more application processors 210, and optionally the one or more direct dataflow compute-in-memory accelerators 220. The compute system 200 can further include one or more input/output interfaces 250-270. For example, the compute system 200 can include a display 250, one or more cameras 260, one or more speakers, one or more microphones, a keyboard, a pointing device, one or more network interface cards and or the like. The compute system 200 can further include any number of other computing system components that are not necessary for an understanding of aspects of the present technology and therefore are not described herein.

The one or more direct dataflow compute-in-memory accelerators 220 can be configured to execute one or more artificially intelligence tasks, neural processing tasks, machine learning tasks, big data analytics tasks or the like. For ease of explanation, artificially intelligence, neural processing, machine learning, big data analytics and the like will be referred to hereinafter simply as artificial intelligence.

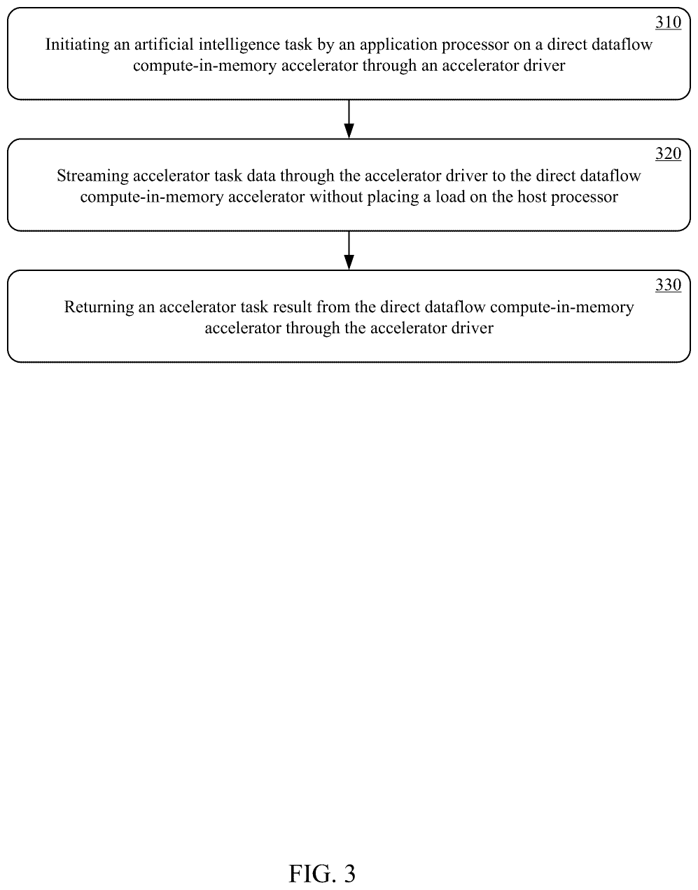

Operation of the computing system 200 will be further explained with reference to FIG. 3, which shows an artificial intelligence accelerator method, in accordance with aspects of the present technology. The method may be implemented as computing device-executable instructions (e.g., computer program) that are stored in computing device-readable media (e.g., computer memory) and executed by a computing device (e.g., processor). The method can include initiating an artificial intelligence task on the direct dataflow compute-in-memory accelerators through an accelerator driver, at 310. An application executing on the application processor 210 (e.g., host processor) can initiate execution an artificial intelligence task on one or more direct dataflow compute-in-memory processors 220 through an accelerator driver. At 320, accelerator task data can be streamed through the accelerator driver to the direct data flow compute-in-memory accelerator. The accelerator task data can be streamed to the one or more direct data flow compute-in-memory accelerators 220 without placing a load on the host processor 210. The one or more direct dataflow compute-in-memory accelerators 220 can execute the accelerator task on the accelerator task data to generate one or more accelerator task results without placing a load on the one or more application processors 210. At 330, one or more accelerator task results can be returned from the one or more direct dataflow compute-in-memory accelerators through the accelerator driver. The accelerator driver can return the one or more accelerator task results from the one or more direct dataflow compute-in-memory accelerators to the operating system or a given application executing on the one or more application processors 210.

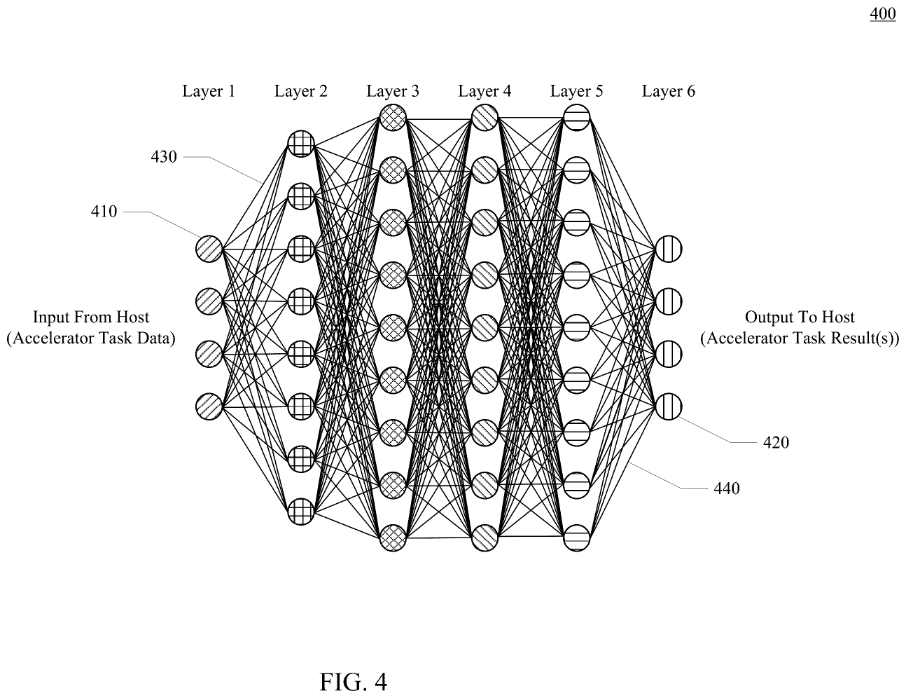

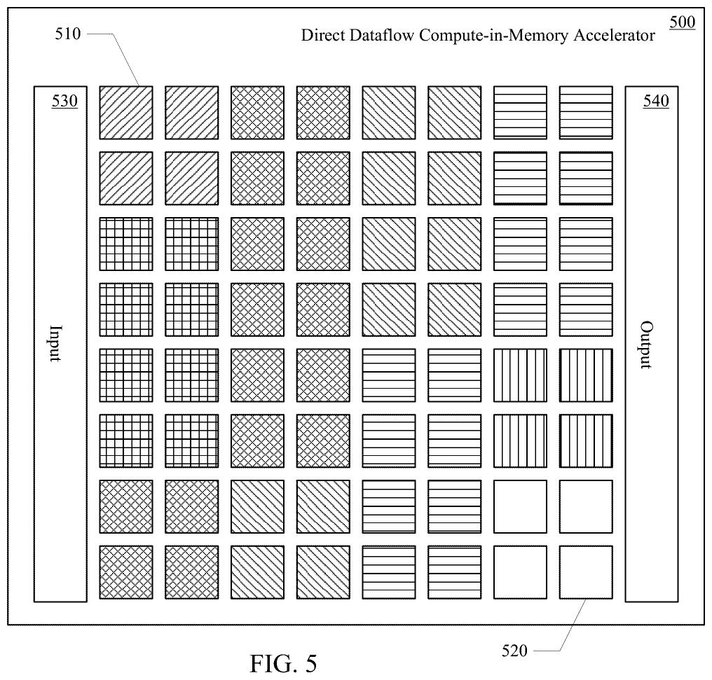

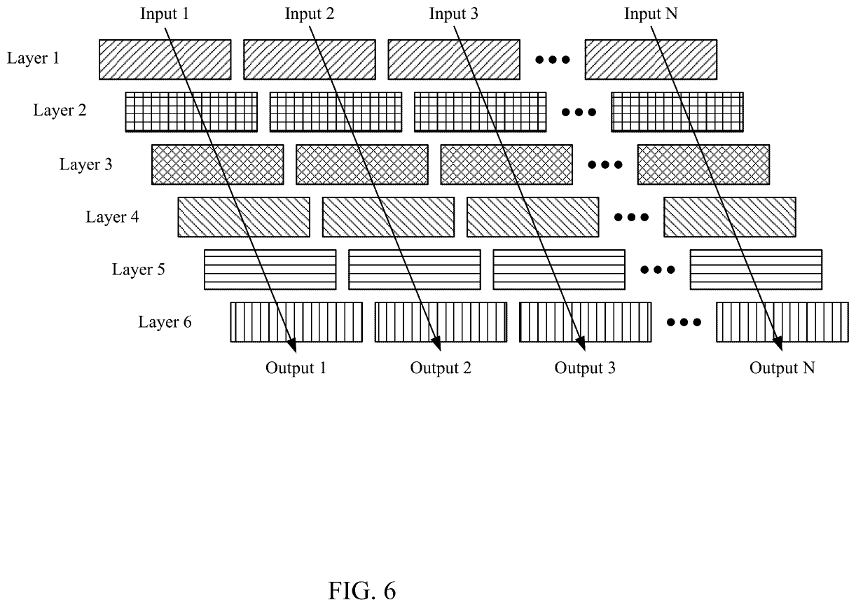

Referring now to FIG. 4, an exemplary accelerator task, such as but not limited to an artificial intelligence (AI) model, in accordance with aspects of the present technology, is illustrated. The illustrated accelerator model 400 is not representative of any particular accelerator model, but instead illustrates the general concept of accelerator models in accordance with aspects of the present technology. The accelerator model 400 can include a plurality of nodes 410-420 arranged in one or more layers, and edges 430-440 coupling the plurality of nodes 410-420 in a particular configuration to implement a given task. Referring now to FIG. 5, an exemplary direct dataflow compute-in-memory accelerator, in accordance with aspects of the present technology, is illustrated. The illustrated direct dataflow compute-in-memory accelerator is not representative of any particular accelerator, but instead illustrates the general concept of direct dataflow compute-in-memory accelerators in accordance with aspects of the present technology. The direct dataflow compute-in-memory accelerator 500 can include a plurality of compute cores 510-520, and one or more input and output stages 530, 540. The nodes 410-420 of a given accelerator model 400 can be mapped to compute cores 510-520 of the direct dataflow compute-in-memory accelerator 500, and the compute cores are direct dataflow coupled based on the edges 430-440 of the accelerator model 400. For example, a set of four compute cores can be configured to implement the nodes of the first layer of the accelerator model 400, a set of eight compute cores can be configured to implement the nodes of the second layer, and so on. Direct dataflow between the configured compute cores can be configured based on the edges coupling respective nodes in different layers to each other. Input from a host, such as the accelerator task data, can be received at the input stage 530 of the direct dataflow compute-in-memory accelerator 500. The results can be output at the output stage 540 from the direct dataflow compute-in-memory accelerator 500. Referring now to FIG. 6, an exemplary execution of an accelerator model, such as an artificial intelligence (AI) image recognition task, in accordance with aspects of the present technology, is illustrated. A first input, such as a first image frame, can be input to the set of compute cores implementing the first layer of nodes of the accelerator model. The data directly flows from the compute cores for the nodes of the respective layers of the accelerator module until a result such as a bounding box, class and or confidence level is out. When the first layer completes computation on the first input, a second input can be input to the compute cores of the first layer, and so on in a pipelined architecture.

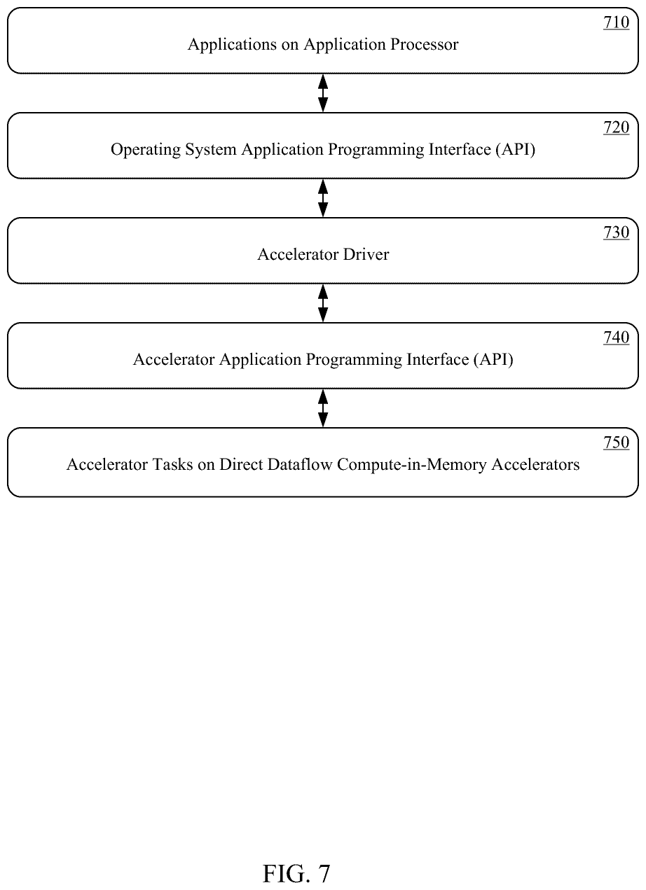

Referring now to FIG. 7, a programming stack of the compute system 200, in accordance with aspects of the present technology, is shown. The programming stack can include one or more applications executing on the one or more application processors 710. The applications executing on the application processors can communicate though one or more operating system application programming interfaces 720 with one or more accelerator drivers 730. The accelerator drivers 730 can execute on the one or more application processors or the one or more direct dataflow compute-in-memory accelerators, or execution can be distributed across the one or more application processor and the one or more direct dataflow compute-in-memory accelerators. The one or more accelerator drivers 730 can communicate through one or more accelerator application programming interfaces (API) 740 with one or more accelerator tasks executing on the one or more direct dataflow compute-in-memory accelerators 750.

Referring again to FIG. 2, the accelerator driver is configured to stream accelerator task data from the one or more application processors 210 to the one or more direct dataflow compute-in-memory accelerators 220. By way of example, but not limited thereto, the accelerator driver can stream image frames captured by one or more cameras 260 to one or more direct dataflow compute-in-memory accelerators 220. The one or more direct dataflow compute-in-memory accelerators 220 can execute one or more accelerator tasks on the accelerator task data to generate one or more accelerator task results. By way of example, but not limited thereto, the one or more direct dataflow compute-in-memory accelerators 220 can generate bounding boxes, classifications, confidence levels thereof and or the like in accordance with a given image recognition model. The accelerator driver can be further configured to return the accelerator task results from the one or more direct dataflow compute-in-memory accelerators 220 to the application processor 210.

In one implementation, an application executing on the one or more application processors 210 can initiate or activate an accelerator task on the one or more direct dataflow compute-in-memory accelerators 220 through the accelerator driver. Thereafter, the accelerator driver can receive the streamed accelerator task data from an application programming interface (API) of the operating system executing on the one or more application processors 210, and can pass the streamed accelerator task data to an application programming interface of the accelerator task executing on one or more of the direct dataflow compute-in-memory accelerators 220. The accelerator task results can be received by the accelerator driver from the application programming interface (API) of the accelerator task, and can be passed by the accelerator driver to the application programming interface (API) of the operating system or directly to a given application executing on the one or more application processors 210.

The accelerator driver can be application processor agnostic and application programming interface agnostic. Accordingly, the accelerator driver can work with any processor hardware architecture, such as but not limited to x86 processor, Xilinx, NXP, MTK, or Rockchip. The accelerator driver can also be direct dataflow compute-in-memory accelerator agnostic and accelerator application programming interface (API) agnostic. Accordingly, the accelerator driver can work with any operating system, including but not limited to Linux, Ubuntu or Andriod. In addition, the accelerator driver can work with various direct dataflow compute-in-memory accelerator architecture. The accelerator driver can couple any number of direct dataflow compute-in-memory accelerators to the one or more host processors. Accordingly, accelerator task performance scales equally across any application processor architecture and operating system. Furthermore, accelerator task performance scales linearly with the number of direct dataflow compute-in-memory accelerators utilized.

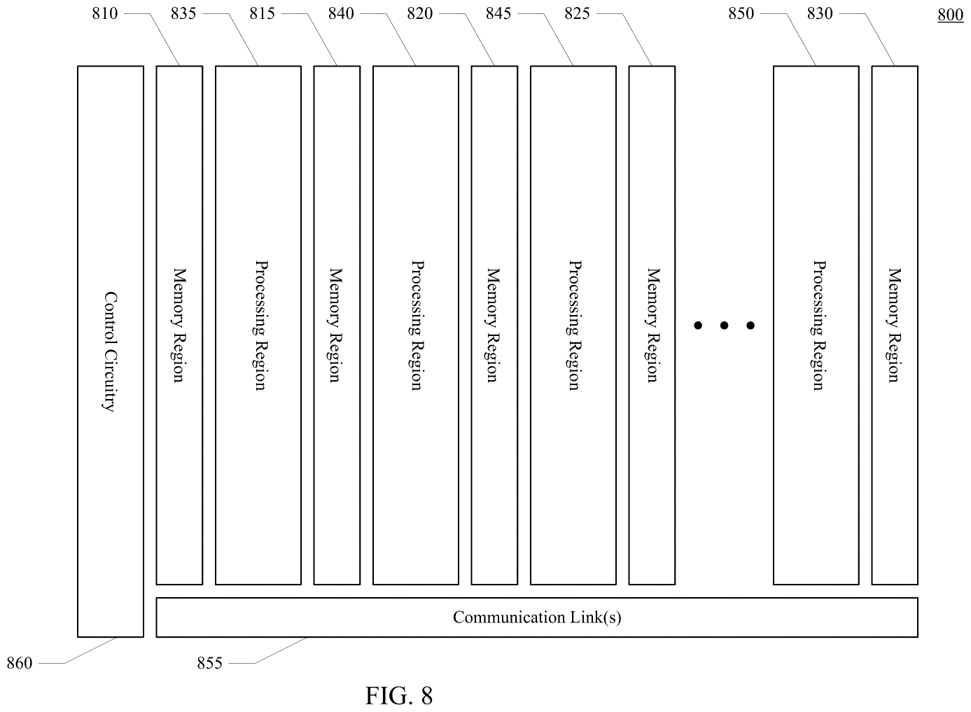

Referring now to FIG. 8, a direct dataflow compute-in-memory accelerator, in accordance with aspects of the present technology, is shown. The direct dataflow compute-in-memory accelerator 800 can include a plurality of memory regions 810-830, a plurality of processing regions 835-850, one or more communication links 855, and one or more centralized or distributed control circuitry 860. The plurality of memory regions 810-830 can also be referred to as activation memory. The plurality of processing regions 835-850 can be interleaved between the plurality of memory regions 810-830. In one implementation, the plurality of memory regions 810-830 and the plurality of processing regions 835-850 can have respective predetermine sizes. The plurality of processing regions 835-850 can have the same design. Similarly, the plurality of memory region 810-830 can also have the same design. In one implementation, the plurality of memory regions 810-830 can be static random access memory (SRAM), and the plurality of processing regions can include one or more arrays of resistive random access memory (ReRAM), magnetic random access memory (MRAM), phase change random access memory (PCRAM), Flash memory (FLASH), or the like. It is to be noted that the interleaving of the plurality of memory regions 810-830 and plurality of processing regions 835-850 can be physical as illustrated, or can be functional (e.g., virtual).

The memory processing units and or compute cores therein can implement computation functions in arrays of memory cells without changing the basic memory array structure. Weight data can be stored in the memory cells of the processing regions 835-850 or compute cores therein, and can be used over a plurality of cycles without reloading the weights from off-chip memory (e.g., system RAM). Furthermore, an intermediate result from a given processing region can be passed through the on-chip memory region 810-830 to another given processing region for use in further computations without writing out to off-chip memory. The compute-in-memory provides for high throughput with low energy consumption. Furthermore, no off-chip random access memory is required. The direct dataflow compute-in-memory architecture provides optimized data movement. The data-streaming based processing provides low latency (Batch=1) without the use of a network-on-chip (NoC) to maximize efficiency of data movement and reduce software complexity. High accuracy can be achieved using B-float activations of 4, 8, 16, or the like, bit weights.

One or more of the plurality of processing regions 835-850 can be configured to perform one or more computation functions, one or more instances of one or more computation functions, one or more segments of one or more computation functions, or the like. For example, a first processing region 835 can be configured to perform two computation functions, and a second processing region 840 can be configured to perform a third computation function. In another example, the first processing region 835 can be configured to perform three instances of a first computation function, and the second processing region 840 can be configured to perform a second and third computation function. The one or more centralized or distributed control circuitry 860 can configure the one or more computation functions of the one or more of the plurality of processing regions 835-850. In yet another example, a given computation function can have a size larger than the predetermined size of the one or more processing regions. In such case, the given computation function can be segmented, and the computation function can be configured to be performed on one or more of the plurality of processing units 835-850. The computation functions can include, but are not limited to, vector products, matrix-dot-products, convolutions, min/max pooling, averaging, scaling, and or the like.

A central direct dataflow direction can be utilized with the plurality of memory regions 810-830 and plurality of processing regions 835-850. The one or more centralized or distributed control circuitry 860 can control dataflow into each given one of the plurality of processing regions 835-850 from a first adjacent one of the plurality of memory regions 810-830 to a second adjacent one of the plurality of memory regions 810-830. For example, the one or more control circuitry 860 can configure data to flow into a first processing region 835 from a first memory region 810 and out to a second memory region 815. Similarly, the one or more control circuitry 860 can configure data to flow into a second processing region 840 from the second memory region 815 and out to a third memory region 820. The control circuitry 860 can include a centralized control circuitry, distributed control circuitry or a combination thereof. If distributed, the control circuitry 860 can be local to the plurality of memory regions 810-830, the plurality of processing regions 835-850, and or one or more communication links 855.

In one implementation, the plurality of memory regions 810-830 and the plurality of processing regions 835-850 can be columnal interleaved with each other. The data can be configured by the one or more centralized or distributed control circuitry 860 to flow between adjacent columnal interleaved processing regions 835-850 and memory regions 810-830 in a cross-columnal direction. In one implementation, the data can flow in a unidirectional cross-columnal direction between adjacent processing regions 835-850 and memory regions 810-830. For example, data can be configured to flow from a first memory region 810 into a first processing region 835, from the first processing region 835 out to a second memory region 815, from the second memory region 815 into a second processing region 840, and so on. In another implementation, the data can flow in a bidirectional cross-columnal direction between adjacent processing regions 835-850 and memory regions 810-830. In addition or alternatively, data within respective ones of the processing region 835-850 can flow between functions within the same processing region. For example, for a first processing region 835 configured to perform two computation functions, data can flow from the first computation function directly to the second computation function without being written or read from an adjacent memory region.

The one or more communication links 855 can be coupled between the interleaved plurality of memory region 810-830 and plurality of processing regions 835-850. The one or more communication links 855 can be configured for moving data between non-adjacent ones of the plurality of memory regions 810-830, between non-adjacent ones of the plurality of processing regions 835-850, or between non-adjacent ones of a given memory region and a given processing region. For example, the one or more communication links 855 can be configured for moving data between the second memory region 815 and a fourth memory region 825. In addition or alternatively, the one or more communication links 855 can be configured for moving data between the first processing region 835 and a third processing region 845. In addition or alternatively, the one or more communication links 855 can be configured for moving data between the second memory region 815 and the third processing region 845, or between the second processing unit 840 and a fourth memory region 125.

Generally, the plurality of memory regions 810-830 and the plurality of processing regions 835-850 are configured such that partial sums move in a given direction through a given processing region. In addition, the plurality of memory regions 810-830 and the plurality of processing regions 835-850 are generally configured such that edge outputs move in a given direction from a given processing region to an adjacent memory region. The terms partial sums and edge outputs are used herein to refer to the results of a given computation function or a segment of a computation function.

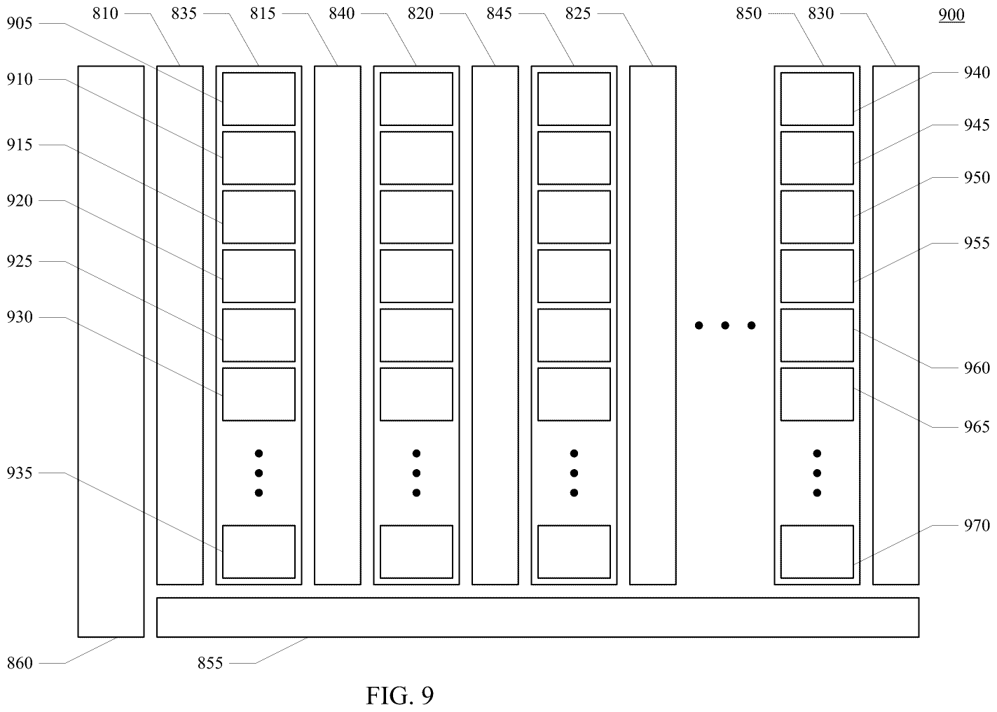

Referring now to FIG. 9, a direct dataflow compute-in-memory accelerator, in accordance with embodiments of the present technology, is shown. The direct dataflow compute-in-memory accelerator 900 can include a plurality of memory regions 810-830, a plurality of processing regions 835-850, one or more communication links 855, and one or more centralized or distributed control circuitry 860. The plurality of processing regions 835-850 can be interleaved between the plurality of memory regions 810-830. In one implementation, the plurality of memory regions 810-830 and the plurality of processing regions 835-850 can be columnal interleaved with each other. In one implementation, the plurality of memory region 810-830 and the plurality of processing regions 835-850 can have respective predetermined sizes.

Each of the plurality of processing regions 835-850 can include a plurality of compute cores 905-970. In one implementation, the plurality of compute cores 905-970 can have a predetermined size. One or more of the compute cores 905-970 of one or more of the processing regions 835-850 can be configured to perform one or more computation functions, one or more instance of one or more computation functions, one or more segments of one or more computation function, or the like. For example, a first compute core 905 of a first processing region 835 can be configured to perform a first computation function, a second compute core 910 of the first processing region 835 can be configured to perform a second computation function, and a first compute core of a second processing region 840 can be configured to perform a third computation function. Again, the computation functions can include but are not limited to vector products, matrix-dot products, convolutions, min/max pooling, averaging, scaling, and or the like.

The one or more centralized or distributed control circuitry 860 can also configure the plurality of memory regions 810-830 and the plurality of processing regions 835-850 so that data flows into each given one of the plurality of processing regions 835-850 from a first adjacent one of the plurality of memory region 810-830 to a second adjacent one of the plurality of memory regions 810-830. For example, the one or more control circuitry 860 can configure data to flow into a first processing region 835 from a first memory region 810 and out to a second memory region 815. Similarly, the one or more control circuitry 860 can configure data to flow into a second processing region 840 from the second memory region 815 and out to a third memory region 820. In one implementation, the control circuitry 860 can configure the plurality of memory regions 810-830 and the plurality of processing regions 835-850 so that data flows in a single direction. For example, the data can be configured to flow unidirectionally from left to right across one or more processing regions 835-850 and the respective adjacent one of the plurality of memory regions 810-830. In another implementation, the control circuitry 860 can configure the plurality of memory regions 810-830 and the plurality of processing regions 835-850 so that data flows bidirectionally across one or more processing regions 835-850 and the respective adjacent one of the plurality of memory regions 810-830. In addition, the one or more control circuitry 860 can also configure the data to flow in a given direction through one or more compute cores 905-970 in each of the plurality of processing regions 835-850. For example, the data can be configured to flow from top to bottom from a first compute core 905 through a second compute core 910 to a third compute core 915 in a first processing region 835. The direct dataflow compute-in-memory accelerators in accordance with FIGS. 8 and 9 are further described in U.S. patent application Ser. No. 16/841,544, filed Apr. 6, 2020, and U.S. patent application Ser. No. 16/894,588, filed Jun. 5, 2020, which are incorporated herein by reference.

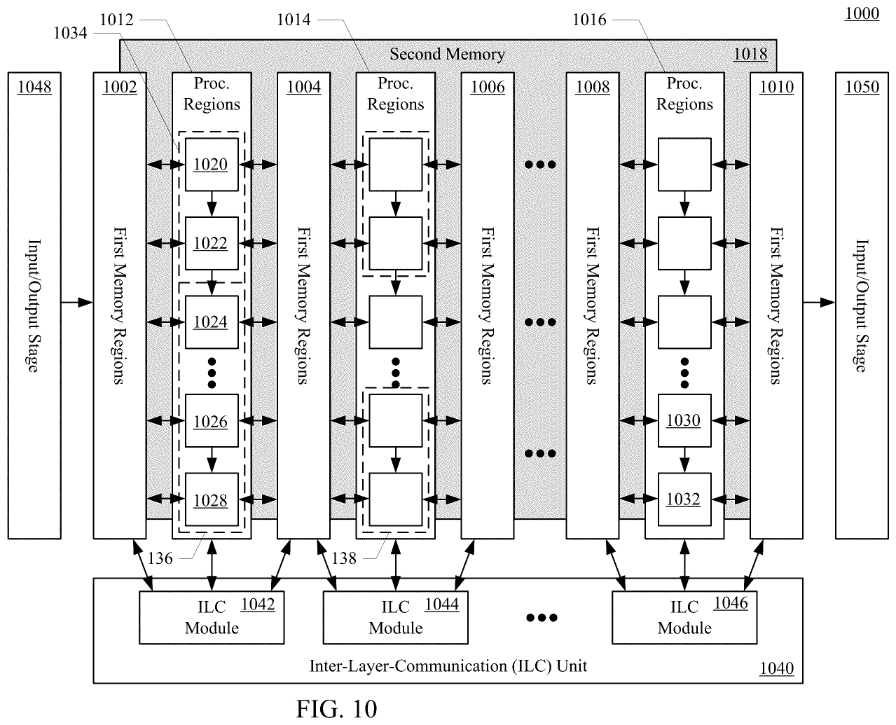

Referring to FIG. 10, a direct dataflow compute-in-memory accelerator, in accordance with aspects of the present technology, is shown. The direct dataflow compute-in-memory accelerator 1000 can include a first memory including a plurality of regions 1002-1010, a plurality of processing regions 1012-1016 and a second memory 1018. The second memory 1018 can be coupled to the plurality of processing regions 1012-1016. The second memory 1018 can optionally be logically or physically organized into a plurality of regions. The plurality of regions of the second memory 1018 can be associated with corresponding ones of the plurality of processing region 1012-1016. In addition, the plurality of regions of the second memory 1018 can include a plurality of blocks organized in one or more macros. The first memory 1002-1010 can be volatile memory, such as static random-access memory (SRAM) or the like. The second memory can be non-volatile memory, such as resistive random-access memory (RRAM), magnetic random-access memory (MRAM), flash memory (FLASH) or the like. The second memory can alternatively be volatile memory. In one implementation, the first memory 102-110 can be data memory, feature memory or the like, and the second memory 118 can be weight memory. Generally, the second memory can be high density, local and wide read memory.

The plurality of processing regions 1012-1016 can be interleaved between the plurality of regions of the first memory 1002-1010. The processing regions 1012-1016 can include a plurality of compute cores 1020-1032. The plurality of compute cores 1020-1032 of respective ones of the plurality of processing regions 1012-1016 can be coupled between adjacent ones of the plurality of regions of the first memory 1002-1010. For example, the compute cores 1020-1028 of a first processing region 1012 can be coupled between a first region 1002 and a second region 1004 of the first memory 1002-1010. The compute cores 1020-1032 in each respective processing region 1012-1016 can be configurable in one or more clusters 1034-1038. For example, a first set of compute cores 1020, 1022 in a first processing region 1012 can be configurable in a first cluster 1034. Similarly, a second set of compute cores 1024-1028 in the first processing region can be configurable in a second cluster 1036. The plurality of compute cores 1020-1032 of respective ones of the plurality of processing regions 1012-1016 can also be configurably couplable in series. For example, a set of compute cores 1020-1024 in a first processing region 1012 can be communicatively coupled in series, with a second compute core 1022 receiving data and or instructions from a first compute core 1020, and a third compute core 1024 receiving data and or instructions from the second compute core 1022.

The direct dataflow compute-in-memory accelerator 1000 can further include an inter-layer-communication (ILC) unit 1040. The ILC unit 1040 can be global or distributed across the plurality of processing regions 1012-1016. In one implementation, the ILC unit 1040 can include a plurality of ILC modules 1042-1046, wherein each ILC module can be coupled to a respective processing regions 1012-1016. Each ILC module can also be coupled to the respective regions of the first memory 1002-1010 adjacent the corresponding respective processing regions 1012-1016. The inter-layer-communication unit 1040 can be configured to synchronize data movement between one or more compute cores producing given data and one or more other compute cores consuming the given data.

The direct dataflow compute-in-memory accelerator 1000 can further include one or more input/output stages 1048, 1050. The one or more input/output stages 1048, 1050 can be coupled to one or more respective regions of the first memory 1002-1010. The one or more input/output stages 1048, 1050 can include one or more input ports, one or more output ports, and or one or more input/output ports. The one or more input/output stages 1048, 1050 can be configured to stream data into or out of the direct dataflow compute-in-memory accelerator 1000. For example, one or more of the input/output (I/O) stages can be configured to stream accelerator task data into a first one of the plurality of regions of the first memory 202-210. Similarly, one or more input/output (I/O) stages can be configured to stream task result data out of a last one of the plurality of regions of the first memory 202-210.

The plurality of processing regions 1012-1016 can be configurable for memory-to-core dataflow from respective ones of the plurality of regions of the first memory 1002-1010 to one or more cores 1020-1032 within adjacent ones of the plurality of processing regions 1012-1016. The plurality of processing regions 1012-1016 can also be configurable for core-to-memory dataflow from one or more cores 1020-1032 within ones of the plurality of processing regions 1012-1016 to adjacent ones of the plurality of regions of the first memory 1002-1010. In one implementation, the dataflow can be configured for a given direction from given ones of the plurality of regions of the first memory 1002-1010 through respective ones of the plurality of processing regions to adjacent ones of the plurality of regions of the first memory 1002-1010.

The plurality of processing regions 1012-1016 can also be configurable for memory-to-core data flow from the second memory 1018 to one or more cores 1020-1032 of corresponding ones of the plurality of processing regions 1012-1016. If the second memory 1018 is logically or physically organized in a plurality of regions, respective ones of the plurality of regions of the second memory 1018 can be configurably couplable to one or more compute cores in respective ones of the plurality of processing regions 1012-1016.

The plurality of processing regions 1012-1016 can be further configurable for core-to-core data flow between select adjacent compute cores 1020-1032 in respective ones of the plurality of processing regions 1012-1016. For example, a given core 1024 can be configured to pass data accessed from an adjacent portion of the first memory 1002 with one or more other cores 1026-1028 configurably coupled in series with the given compute core 1024. In another example, a given core 1020 can be configured to pass data access from the second memory 1018 with one or more other cores 1022 configurably coupled in series with the given compute core 1020. In yet another example, a given compute core 1020 can pass a result, such as a partial sum, computed by the given compute core 1020 to one or more other cores 1022 configurably coupled in series with the given compute core 1020.

The plurality of processing regions 1012-1016 can include one or more near memory (M) cores. The one or more near memory (M) cores can be configurable to compute neural network functions. For example, the one or more near memory (M) cores can be configured to compute vector-vector products, vector-matrix products, matrix-matrix products, and the like, and or partial products thereof. The plurality of processing regions 1012-1016 can also include one or more arithmetic (A) cores. The one or more arithmetic (A) cores can be configurable to compute arithmetic operations. For example, the arithmetic (A) cores can be configured to compute merge operation, arithmetic calculation that are not supported by the near memory (M) cores, and or the like. The plurality of the inputs and output regions 1048, 1050 can also include one or more input/output (I/O) cores. The one or more input/output (I/O) cores can be configured to access input and or output ports of the direct dataflow compute-in-memory accelerator 1000. The term input/output (I/O) core as used herein can refer to cores configured to access input ports, cores configured to access output ports, or cores configured to access both input and output ports.

The compute cores 1020-1032 can include a plurality of physical channels configurable to perform computations, accesses and the like simultaneously with other cores within respective processing regions 1012-1016, and or simultaneously with other cores in other processing regions 1012-1016. The compute cores 1020-1032 of respective ones of the plurality of processing regions 1012-1016 can be associated with one or more blocks of the second memory 1018. The compute cores 1020-1032 of respective ones of the plurality of processing regions 1012-1016 can be associated with respective slices of the second plurality of memory regions. The cores 1020-1032 can include a plurality of configurable virtual channels.

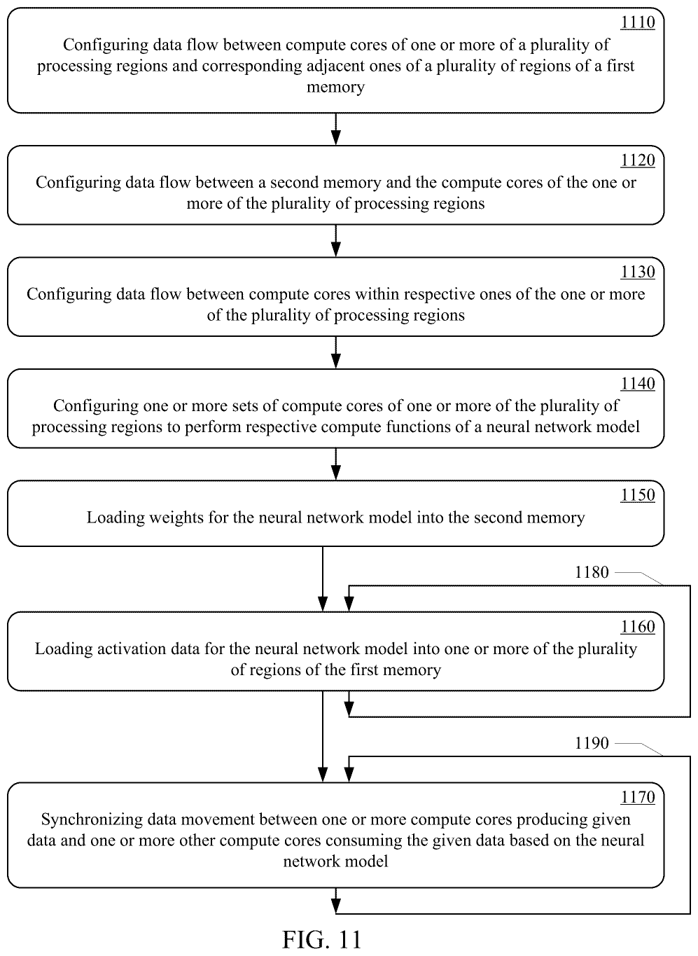

Referring now to FIG. 11, a direct dataflow compute-in-memory accelerator, in accordance with aspects of the present technology, is shown. The method will be explained with reference to the direct dataflow compute-in-memory accelerator 1000 of FIG. 10. The method can include configuring dataflow between compute cores of one or more of a plurality of processing regions 1012-1016 and corresponding adjacent ones of the plurality of regions of the first memory, at 1110. At 1120, data flow between the second memory 1018 and the compute cores 1020-1032 of the one or more of the plurality of processing regions 1012-1016 can be configured. At 1130, data flow between compute cores 1020-1032 within respective ones of the one or more of the plurality of processing regions 1012-1016 can be configured. Although the processes of 1110-1130 are illustrated as being performed in series, it is appreciated that the processes can be performed in parallel or in various combinations of parallel and sequential operations.

At 1140, one or more sets of compute cores 1020-1032 of one or more of the plurality of processing regions 1012-1016 can be configured to perform respective compute functions of a neural network model. At 1150, weights for the neural network model can be loaded into the second memory 1018. At 1160, activation data for the neural network model can be loaded into one or more of the plurality of regions of the first memory 1002-1010.

At 1170, data movement between one or more compute cores producing given data and one or more other compute cores consuming the given data can be synchronized based on the neural network model. The synchronization process can be repeated at 1180 for processing the activation data of the neural network model. The synchronization process can include synchronization of the loading of the activation data of the neural network model over a plurality of cycles, at 190. The direct dataflow compute-in-memory accelerators in accordance with FIGS. 10 and 11 are further described in PCT Patent Application No. PCT/US21/48498, filed Aug. 31, 2021, PCT Patent Application No. PCT/US21/48466, filed Aug. 31, 2021, PCT Patent Application No. PCT/US21/48550, filed Aug. 31, 2021, and PCT Patent Application No. PCT/US21/48548, filed Aug. 31, 2021, which are incorporated herein by reference.

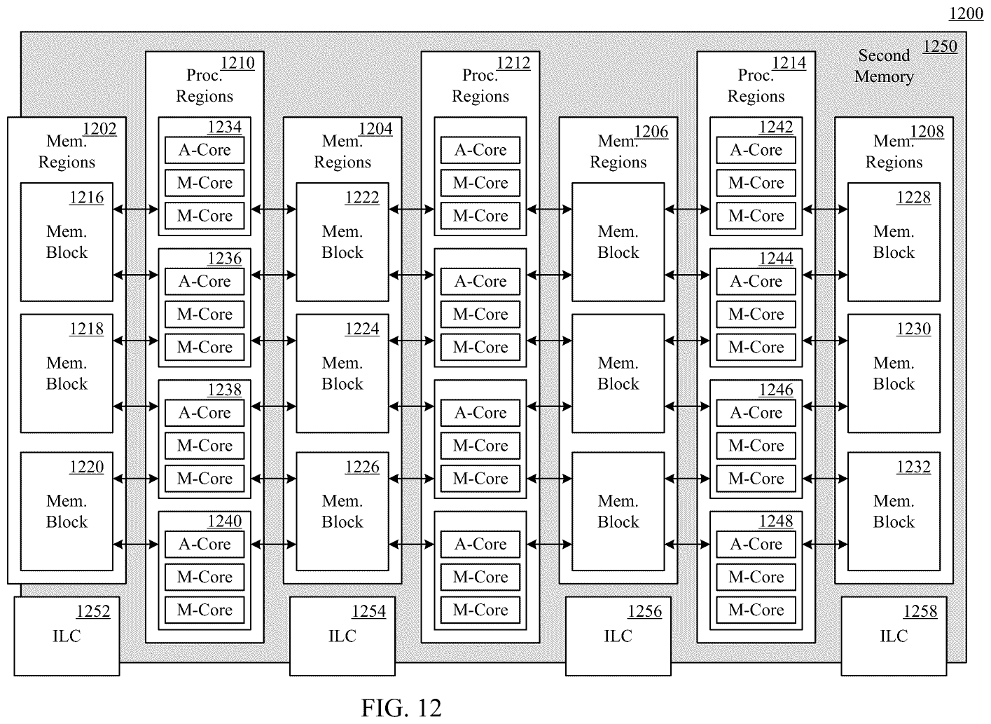

Referring now to FIG. 12, a direct dataflow compute-in-memory accelerator, in accordance with aspects of the present technology, is shown. The direct dataflow compute-in-memory accelerator 1200 can include a first memory 1202-1208 and a plurality of processing region 1210-1214. The first memory can include a plurality of memory regions 1202-1208. The plurality of processing regions 1210-1214 can be interleaved between the plurality of memory regions 1202-1208 of the first memory. In one implementation, the plurality of first memory regions 1202-1208 and the plurality of processing regions 1210-1214 can have respective predetermine sizes. One or more of the plurality of memory regions 1202-1208 can include a plurality of memory blocks 1216-1232. One or more processing regions 1210-1214 can also include plurality of core groups 1234-1248. A core group 1234-1248 can include one or more computer cores. The computer cores in a respective core group can be arranged in one or more compute clusters. One or more of the plurality of core groups of a respective one of the plurality of processing regions can be coupled between adjacent ones of the plurality of memory regions of the first memory. In one implementation, a given core group can be coupled to a set of directly adjacent memory blocks, while not coupled to the other memory blocks of the adjacent memory regions. In other words, a core group of a respective processing region can be coupled to a set of memory blocks that are proximate to the given core group, while not coupled to memory blocks in the adjacent memory regions that are distal from the given core group. For example, a first core group 1234 of a first processor region 1210 can be coupled between a first memory block 1216 of a first memory region 1202 and a first memory block 1222 of a second memory region 1204. A second core group 1236 of the first processor region 1210 can be coupled to the first and a second memory block 1216, 1218 of the first memory region 1202 and the first and a second memory block 1222, 1224 of the second memory region 1204. The second core group 1236 of the first processor region 1210 can also be coupled between the first and a third core group 1234, 1238 of the first processor region 1210.

The direct dataflow compute-in-memory accelerator 1200 can also include a second memory 1250. The second memory 1250 can be coupled to the plurality of processing regions 1210-1214. The second memory 1250 can optionally be logically or physically organized into a plurality of regions (not shown). The plurality of regions of the second memory 1250 can be associated with corresponding ones of the plurality of processing region 1210-1214. In addition, the plurality of regions of the second memory 1250 can include a plurality of blocks organized in one or more macros. The second memory can be non-volatile memory, such as resistive random-access memory (RRAM), magnetic random-access memory (MRAM), flash memory (FLASH) or the like. The second memory can alternatively be volatile memory.

One or more of the compute cores, and or one or more core groups of the plurality of processing regions 1210-1214 can be configured to perform one or more computation functions, one or more instances of one or more computation functions, one or more segments of one or more computation functions, or the like. For example, a first computer core, a first core group 1234 or a first processing region 1210 can be configured to perform two computation functions, and a second computer core, second core group or second processing region 1212 can be configured to perform a third computation function. In another example, the first compute core, the first core group 1234 or the first processing region 1210 can be configured to perform three instances of a first computation function, and the second compute core, second core group or the second processing region 1212 can be configured to perform a second and third computation function. In yet another example, a given computation function can have a size larger than the predetermined size of a compute core, core group or one or more processing regions. In such case, the given computation function can be segmented, and the computation function can be configured to be performed on one or more compute cores, one or more core groups or one or more of the processing regions 1210-1214. The computation functions can include, but are not limited to, vector products, matrix-dot-products, convolutions, min/max pooling, averaging, scaling, and or the like.

The data can be configured by the one or more centralized or distributed control circuitry (not shown) to flow between adjacent columnal interleaved processing regions 1210-1214 and memory regions 1202-1208 in a cross-columnal direction. In one implementation, one or more communication links can be coupled between the interleaved plurality of memory region 1202-1208 and plurality of processing regions 1210-1214. The one or more communication links can also be configured for moving data between non-adjacent ones of the plurality of memory regions 1202-1208, between non-adjacent ones of the plurality of processing regions 1210-1214, or between non-adjacent ones of a given memory region and a given processing region.

The direct dataflow compute-in-memory accelerator 1200 can also include one or more inter-layer communication (ILC) units. The ILC unit can be global or distributed across the plurality of processing regions 1210-1214. In one implementation, the ILC unit can include a plurality of ILC modules 1250-1256, wherein each ILC module can be coupled to adjacent respective processing regions 1210-1214. Each ILC module 1252-1258 can also be coupled to adjacent respective regions of the first memory 1202-1208. The inter-layer-communication modules 1250-1256 can be configured to synchronize data movement between one or more compute cores producing given data and one or more other compute cores consuming the given data.

The plurality of processing regions 1210-1214 can be configurable for memory-to-core dataflow from respective ones of the plurality of regions of the first memory 1202-1208 to one or more cores within adjacent ones of the plurality of processing regions 1210-1214. The plurality of processing regions 1210-1214 can also be configurable for core-to-memory dataflow from one or more cores within ones of the plurality of processing regions 1210-1214 to adjacent ones of the plurality of regions of the first memory 1202-1208. In one implementation, the dataflow can be configured for a given direction from given ones of the plurality of regions of the first memory 1202-1208 through respective ones of the plurality of processing regions to adjacent ones of the plurality of regions of the first memory 1202-1208.

The plurality of processing regions 1210-1214 can also be configurable for memory-to-core data flow from the second memory 1210 to one or more cores of corresponding ones of the plurality of processing regions 1210-1214. If the second memory 1250 is logically or physically organized in a plurality of regions, respective ones of the plurality of regions of the second memory 1250 can be configurably couplable to one or more compute cores in respective ones of the plurality of processing regions 1210-1214.

The plurality of processing regions 1210-1214 can be further configurable for core-to-core data flow between select adjacent compute cores in respective ones of the plurality of processing regions 1210-1214. For example, a given core can be configured to pass data accessed from an adjacent portion of the first memory 1202 with one or more other cores configurably coupled in series with the given compute core. In another example, a given core can be configured to pass data accessed from the second memory 1250 with one or more other cores configurably coupled in series with the given compute core. In yet another example, a given compute core can pass a result, such as a partial sum, computed by the given compute core to one or more other cores configurably coupled in series with the given compute core.

The plurality of processing regions 1210-1214 can include one or more near memory (M) compute cores. The one or more near memory (M) compute cores can be configurable to compute neural network functions. For example, the one or more near memory (M) compute cores can be configured to compute vector-vector products, vector-matrix products, matrix-matrix products, and the like, and or partial products thereof. The plurality of processing regions 1210-1214 can also include one or more arithmetic (A) compute cores. The one or more arithmetic (A) compute cores can be configurable to compute arithmetic operations. For example, the arithmetic (A) compute cores can be configured to compute merge operations, arithmetic calculations that are not supported by the near memory (M) compute cores, and or the like. A plurality of input and output regions (not shown) can also include one or more input/output (I/O) cores. The one or more input/output (I/O) cores can be configured to access input and or output ports of the direct dataflow compute-in-memory accelerator 1200. The term input/output (I/O) core as used herein can refer to cores configured to access input ports, cores configured to access output ports, or cores configured to access both input and output ports.

The compute cores of the core groups 1234-1248 of the processing regions 1210-1214 can include a plurality of physical channels configurable to perform computations, accesses and the like, simultaneously with other cores within respective core groups 1234-1248 and or processing regions 1210-1214, and or simultaneously with other cores in other core groups 434-448 and or processing regions 1210-1214. The compute cores can also include a plurality of configurable virtual channels.

In accordance with aspects of the present technology, a neural network layer, a part of a neural network layer, or a plurality of fused neural network layers can be mapped to a single cluster of compute cores or a core group as a mapping unit. A cluster of compute cores is a set of cores of a given processing region that are configured to work together to compute a mapping unit.

Again, the memory processing units and or compute cores therein can implement computation functions in arrays of memory cells without changing the basic memory array structure. Weight data can be stored in the memory cells of the processing regions 1210-1214 or compute cores therein, and can be used over a plurality of cycles without reloading the weights from off-chip memory (e.g., system RAM). Furthermore, an intermediate result from a given processing region can be passed through the on-chip memory region 1210-1214 to another given processing region for use in further computations without writing out to off-chip memory. The compute-in-memory provides for high throughput with low energy consumption. Furthermore, no off-chip random access memory is required. The direct dataflow compute-in-memory architecture provides optimized data movement. The data-streaming based processing provides low latency (Batch=1) without the use of a network-on-chip (NoC) to maximize efficiency of data movement and reduce software complexity. High accuracy can be achieved using B-float activations of 4, 8, 16, or the like, bit weights.

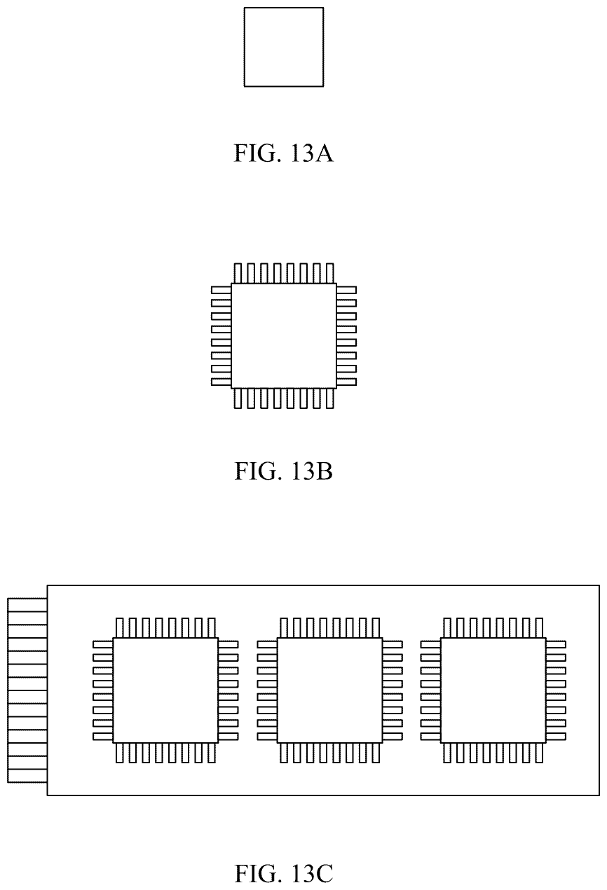

Referring now to FIGS. 13A-13C, exemplary implementations of a direct dataflow compute-in-memory accelerator, in accordance with aspects of the present technology, is shown. The direct dataflow compute-in-memory accelerator can be produced as an integrated circuit (IC) die, such as a chiplet, as illustrated in FIG. 13A. User can combine the direct dataflow compute-in-memory accelerator IC die with other die such as application processors, memory controllers, signal processor and the like in the manufacture of system-in-package (SoP), multi-chip-module, or the like devices. The direct dataflow compute-in-memory accelerator can be produced as a package chip, as illustrated in FIG. 13B. A plurality of dataflow compute-in-memory accelerator can also be employed in a module, such as a M.2, USB stick, or similar printed circuit board assembly, as illustrated in FIG. 13C. The direct dataflow compute-in-memory accelerators can be employed in edge computing applications such as, but not limited to, artificially intelligence, neural processing, machine learning and big data analytics in industrial, internet-of-things (IoT) and transportation applications.

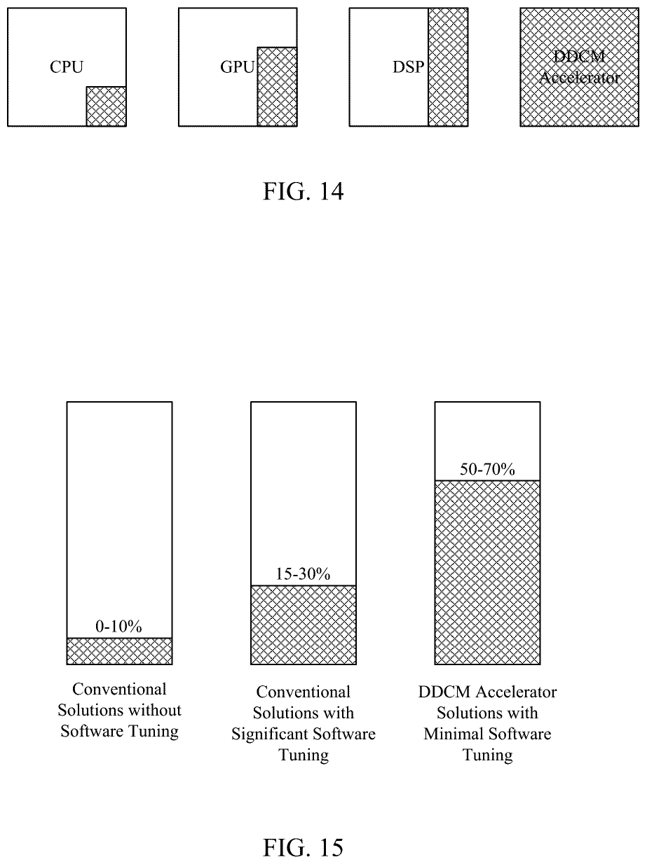

Referring now to FIG. 14, a relative comparison of efficiency of running artificial intelligence (AI) algorithms on various compute cores is illustrated. Deployment of artificial intelligence (AI) algorithms on a general central processing unit (CPU) provides poor computational performance. Domain specific processors, such as graphics processing units (GPUs) and digital signal processors (DSPs) can provide better computing performance as compared to central processing units (CPUs). In contrast, direct dataflow compute-in-memory accelerators, in accordance with aspects of the present technology, can maximize computing performance. Referring now to FIG. 15, a relative comparison of performance of artificial intelligence algorithms in a conventional system and the direct dataflow compute-in-memory accelerator is illustrated. Deployment of an artificial intelligence algorithm on a conventional processing unit, such as a central processing unit (CPU), graphics processing unit (GPU) or digital signal processor (DSP), typically only achieves up to 10% computing utilization. Computing utilization on conventional processing units can be increased to 15-30% with significant software tuning efforts. However, 50-70% computing utilization can be achieved on direct dataflow compute-in-memory accelerator, in accordance with aspects of the present invention, with minimal software tuning.

Aspects of the present technology advantageously provide leading power conservation, compute performance and ease of deployment from the compute-in-memory processing and direct dataflow architecture. Data can advantageously be streamed to the direct dataflow compute-in-memory accelerator utilizing standard communication interfaces, such as universal seral bus (USB) and peripheral component interface express (PCI-e) communication interfaces. Aspects of the direct dataflow compute-in-memory accelerator provide software support for common frameworks, multiple host hardware platforms, and multiple operating systems. The accelerator can readily support TensorFlow, TensorFlow Lite, Keras, ONNX, PyTorch and numerous other software frameworks. The accelerator can support x86, Arm processor, Xilinx, NXP i.MX8, MTK 2712, and numerous other hardware platforms. The accelerator can also support Linux, Ubuntu, Andriod and numerous other operating systems. Direct dataflow compute-in-memory accelerators, in accordance with aspects of the present technology, can use trained artificial intelligence models straight out of the box. Artificial intelligence models subject to model pruning, compression, quantization and the like are also supported, but are not required, on the direct dataflow compute-in-memory accelerators. Software simulators for the direct dataflow compute-in-memory accelerators can be bit-accurate and align with real-world performance, providing accurate frame per second (FPS) and latency measurements. Performance is deterministic with consistent execution times. Therefore, software simulations can accurately match hardware measurements, including but not limited to frame rate and latency. The same artificial intelligence software can be utilized across chip generations of the direct dataflow compute-in-memory accelerators, and is scalable from single to multi-chip deployments. The performance of the direct dataflow compute-in-memory accelerators advantageously scales equally across any application processor and operating system. The performance also advantageously scales linearly with the number of accelerators utilized. Multiple small artificial intelligence models or tasks can run on one accelerator, and large task or models can execute across multiple accelerators using the same software. The same artificial intelligence software can be used for any number of accelerators or models, with only the accelerator driver and firmware be operating system dependent. Accordingly, the direct dataflow compute-in-memory accelerator, in accordance with aspects of the present technology, can be deployed fast, with low use non-recurring engineering (NRE) costs.

The foregoing descriptions of specific embodiments of the present technology have been presented for purposes of illustration and description. They are not intended to be exhaustive or to limit the present technology to the precise forms disclosed, and obviously many modifications and variations are possible in light of the above teaching. The embodiments were chosen and described in order to best explain the principles of the present technology and its practical application, to thereby enable others skilled in the art to best utilize the present technology and various embodiments with various modifications as are suited to the particular use contemplated. It is intended that the scope of the invention be defined by the claims appended hereto and their equivalents.

What is claimed is:

1. A system comprising:
one or more application processors;
one or more direct dataflow compute-in-memory accelerators coupled to the one or more application processors by one or more communication interfaces, wherein the one or more direct dataflow compute-in-memory accelerators execute an accelerator task on accelerator task data to generate an accelerator task result; and
an accelerator driver to stream the accelerator task data from the one or more application processors to the one or more direct dataflow compute-in-memory accelerators and to return the accelerator task result to the one or more application processors.

2. The system of claim 1, wherein one or more direct dataflow compute-in-memory accelerators receive the stream of accelerator task data and execute the accelerator task on the accelerator task data to generate the accelerator task result without placing a load on the one or more application processors.

3. The system of claim 1, wherein the accelerator task calls an accelerator model including nodes and edges for execution on the one or more direct dataflow compute-in-memory accelerators, wherein nodes of the accelerator model are mapped to compute cores of the one or more direct dataflow compute-in-memory accelerators and the compute cores are coupled based on the edges of the accelerator model.

4. The system of claim 1, further comprising:
one or more memories to store an operating system, one or more applications and the accelerator driver for execution on the one or more application processors.

5. The system of claim 4, wherein the accelerator driver:
receives the streamed accelerator task data from an application programming interface (API) of the operating system executing one on the one or more application processors and passes the streamed accelerator task data to an application programming interface (API) of the accelerator task executing on the one or more direct dataflow compute-in-memory accelerators; and
receives the accelerator task result from the application programming interface (API) of the accelerator task and passes the accelerator task result to the application programming interface (API) of the operating system or a given one of the one or more applications executing on the one or more application processors.

6. The system of claim 4, wherein a given one of the one or more applications executing on the one or more application processors initiates the accelerator task on the one or more direct dataflow compute-in-memory accelerators through the accelerator driver.

7. The system of claim 4, wherein the accelerator driver is application processor agnostic.

8. The system of claim 4, wherein the accelerator driver is application programming interface (API) agnostic.

9. The system of claim 4, wherein the accelerator driver is direct dataflow compute-in-memory accelerator agnostic.

10. The system of claim 1, wherein the one or more direct dataflow compute-in-memory accelerators comprise one or more edge direct dataflow compute-in-memory accelerators.

11. The system of claim 1, wherein each of the one or more direct dataflow compute-in-memory accelerators comprise a respective integrated circuit die.

12. The system of claim 1, wherein each of the one or more direct dataflow compute-in-memory accelerators comprise a respective integrated circuit chip package.

13. The system of claim 1, wherein the one or more direct dataflow compute-in-memory accelerators are coupled in a module.

14. An artificial intelligence accelerator method comprising:
initiating an artificial intelligence task by an application processor on a direct dataflow compute-in-memory accelerator through an accelerator driver;
streaming accelerator task data through the accelerator driver to the direct dataflow compute-in-memory accelerator without placing a load on the accelerator processor; and
returning an accelerator task result from the direct dataflow compute-in-memory accelerator through the accelerator driver.

15. The artificial intelligence accelerator method according to claim 14, wherein:
the artificial intelligence task is initiated by an application executing on the host processor; and
the accelerator task result is returned to the application.

16. The artificial intelligence accelerator method according to claim 14, wherein the artificial intelligence task calls an accelerator model including nodes and edges for execution, wherein nodes of the accelerator model are mapped to compute cores of the direct dataflow compute-in-memory accelerator and compute cores are direct dataflow coupled based on the edges of the accelerator model.

17. The artificial intelligence accelerator method according to claim 14, wherein the accelerator driver:
receives the streamed accelerator task data from an application programming interface (API) of an operating system executing one on the host processor and passes the streamed accelerator task data to an application programming interface (API) of the artificial intelligence task executing on the direct dataflow compute-in-memory accelerator; and
receives the accelerator task result from the application programming interface (API) of the accelerator task and passes the accelerator task result to the application programming interface (API) of the operating system or an application executing on the host processor.

18. The artificial intelligence accelerator method according to claim 14, wherein the accelerator driver is host processor agnostic.

19. The artificial intelligence accelerator method according to claim 14, wherein the accelerator driver is operating system agnostic.

20. The artificial intelligence accelerator method according to claim 14, wherein the accelerator driver is direct dataflow compute-in-memory accelerator agnostic.
